(19) United States
(12) Patent Application Publication
(10) Pub. No.: US 2016/0102768 A1
(43) Pub. Date: Apr. 14, 2016

(54) ANGLED DELTA RING SEAL FOR BALL VALVE SEAT

(71) Applicant: Charles LO CICERO, Vaughan (CA)

(72) Inventor: Charles LO CICERO, Vaughan (CA)

(21) Appl. No.: 14/873,557

(22) Filed: Oct. 2, 2015

(30) Foreign Application Priority Data
Oct. 8, 2014 (CA) 2867326

(51) Int. Cl. F16K 5/06; F16J 15/3284

(52) U.S. Cl. CPC F16K 5/0668; F16J 15/3284

(57) ABSTRACT

The resilient delta ring seal for use in a seat for a ball valve is held in the seat having an annular opening for receiving and holding the delta ring seal. An apex of the seal is pointed radially inward toward the ball valve and a base of the seal is orientated radially away from the ball valve. The seal base is wider than the apex. The seal is placed in the seat apposite an annular resin insert having a surface disposed toward the ball valve. The seal apex is truncated obliquely to define a substantially flat apical surface that extends beyond the opening toward the ball valve and terminates at the resin insert.

### CROSS-REFERENCE TO RELATED APPLICATIONS

See the Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OM MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention relates to a ring seal for ball valve seat.

2. Description of Related Art Including Information Disclosed Under 37 CFR 1.97 and 37 CFR 1.98.

Seats for ball valves are well known in the prior art. Balls and seats are composed of specific materials, the type of which depends on several factors, including the temperature and type of fluid flowing through the ball valves. For example, a fluid containing a large amount of particulate matter would require ball and seat materials that are resistant to abrasion.

It is also known to include additional sealing elements within seats to improve shut-off of the valve and to prevent leakage. Common sealing elements include resin inserts and elastomeric seals. The choice of sealing element also depends on factors such as the temperature and type of fluid.

Elastomeric seals are superior to resin inserts for a number of reasons. For example, elastomeric seals are easier to compress, thus requiring a much lower working pressure for sealing as compared to resin (i.e. less force is required to push the seat against the ball). In addition, elastomeric inserts are cheaper to manufacture. Since resin inserts resist compression, they require precise spherical profiles, geometry and ball surface finishes to effect a robust seal. This required precision leads to higher production costs.

Another advantage of elastomeric seals is their ability to form a seal, even when there is a small amount of damage to either the elastomeric seal or the ball surface (i.e. scratches or grooves causes by abrasion for example). Elastomeric materials can “fill in” the grooves and scratches whereas the performance of the more rigid resin seals decreases when there is even a small amount of damage to the resin seal or the ball surface.

A major problem with prior art elastomeric seals, however, is that they are susceptible to damage. For example, as fluid enters a partially open valve, the high pressure causes extrusion of elastomeric seals. In addition, elastomeric seals are susceptible to damage from abrasion by particulate matter that may be present in some fluids. Extrusion of elastomeric inserts becomes more pronounced with pipe diameters greater than about two inches and with high fluid pressures.

On the other hand, resin inserts exhibit several advantages over elastomeric seals. Resin inserts are inert with respect to many types of fluids, and therefore useful for a wide range of applications. Another advantage of resin inserts over elastomeric seals is that resins are virtually impermeable to gas, therefore the use of resin inserts reduces the risk of an explosive decompression of the valve if rapid decompression occurs.

Resin inserts are also more resistant to compression, and thus are useful in applications where metal to metal contact between a ball and a seat is undesirable. Furthermore, resin inserts resist wear and abrasion to a higher degree than elastomeric seals.

What is required is a ball valve seat with improved resistance to extrusion and abrasion, as well as superior seal performance, particularly in ball valves with pipe diameters larger than two inches and high fluid pressures.

### BRIEF SUMMARY OF THE INVENTION

In one embodiment, the present invention is a resilient delta ring seal for use in a seat for a ball valve. The seat has an annular opening for receiving and holding the delta ring seal therein so that an apex of the seal is pointed radially inward toward the valve and a base of the seal is orientated radially away from the ball valve. The seal is placed in a seat apposite an annular resin insert having a surface disposed toward the ball valve. The seal base is wider than the apex, which is truncated obliquely to define a substantially flat apical surface that extends beyond the opening toward the ball valve and terminates at the resin insert. Optimally, the angle between the seal apical surface the resin insert is 34 degrees.

### BRIEF DESCRIPTION OF THE SEVERAL VIEWS OF THE DRAWINGS

FIG. 1 is a ball valve of the prior art.

FIG. 2 is a perspective view of a seat for a ball valve.

FIG. 3 is a perspective view of the side of a seat for a ball valve.

FIG. 4 is a cross-section view through a ball valve and two seats.

FIG. 5 is an enlarged view of a cross-section through a seat shown in FIG. 4.

FIG. 5A is an enlarged view of a cross-section through a delta ring seal and resin insert according to a preferred embodiment of the claimed invention.

FIG. 6 is a perspective view of a delta ring seal.

FIG. 7 is a cross-section view of a delta ring seal through line 7-7.

FIG. 8 is an enlarged view of a cross-section of a delta ring seal shown in FIG. 7.

### DETAILED DESCRIPTION OF THE INVENTION

The present invention is a delta ring seal for inserting within a seat for a ball valve.

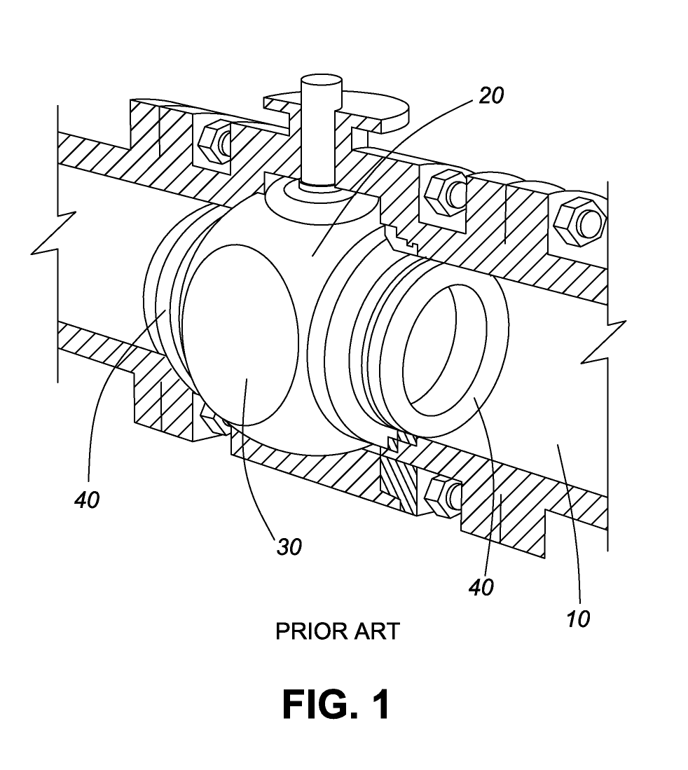

FIG. 1 shows a typical ball valve, inserted within a pipe (10). A ball (20) defining a bore (30), is positioned between two seats (40). Fluid flows through the bore (30) when the valve is turned into an open position. When the ball (20) is rotated to a closed position, the seats (40) cover the bore (30), to prevent leakage of fluid.

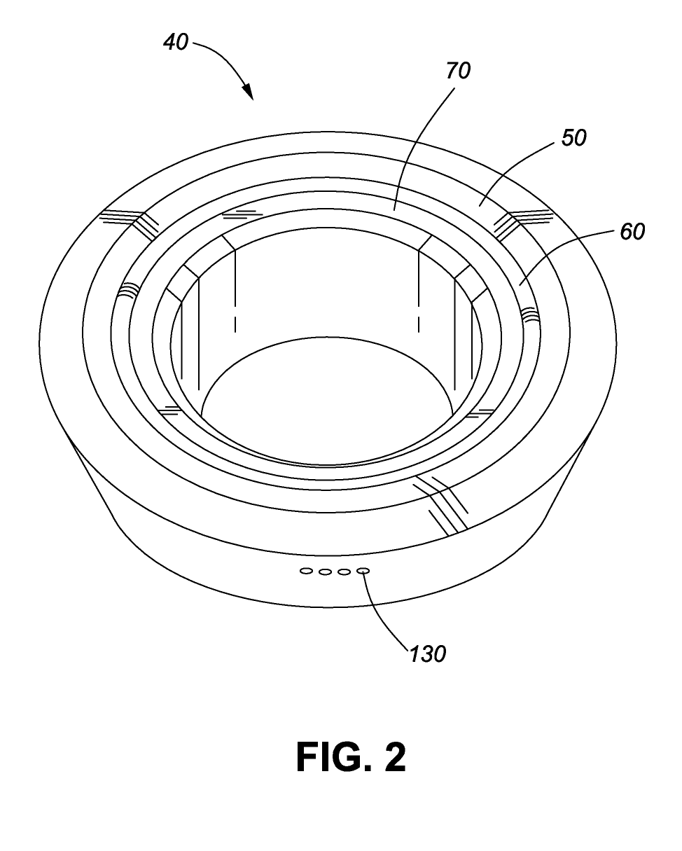

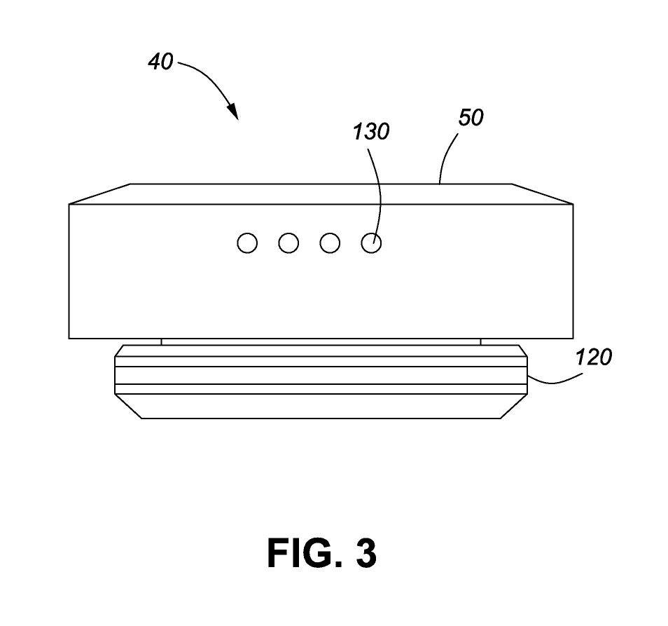

A seat (40) according to the present invention is shown in FIGS. 2 and 3. The seat (40) comprises two ends. A first end (120) is modified for attaching or inserting the ball valve (20) within a pipe (not shown).

A second end (50) of the seat (40) is adapted for sealing the ball valve (20). In the example shown in FIG. 2, two sealing elements prevent leakage of a fluid past the bore (30), namely, an elastomeric delta ring seal (60) and a resin insert (70). In the prior art normally the seal (60) and insert (70) are spaced apart from each other. This spacing apart of seal (60) and insert (70) has been discovered to also lead to seat failure and contribute to seal (60) extrusion. One such improvement in the prior art consists of placing the seal (60) adjacent the insert (70), improving the seal (60) retention strength, thereby decreasing the likelihood of seal (60) extrusion.

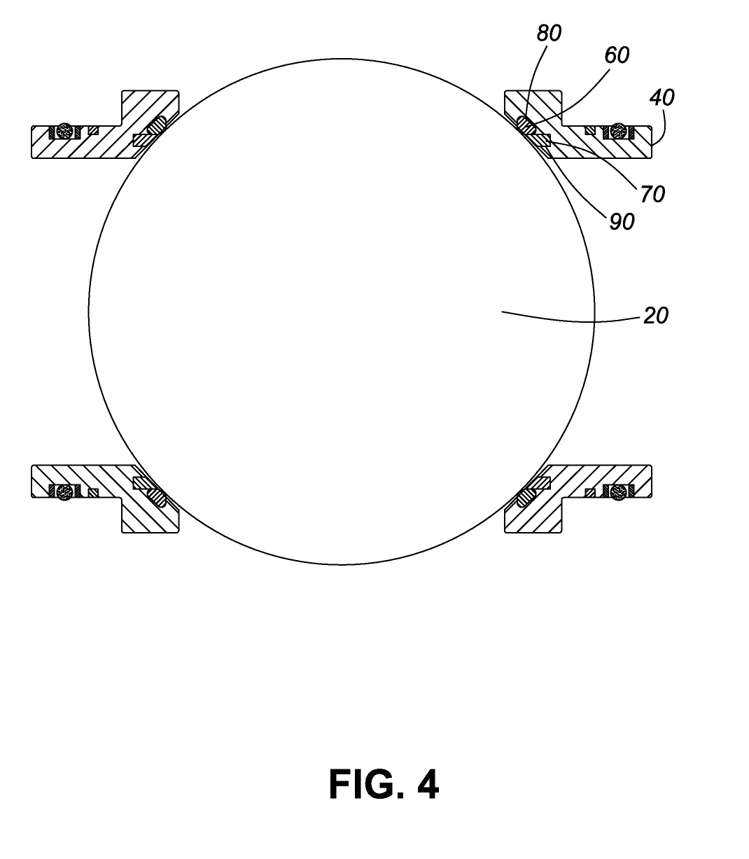

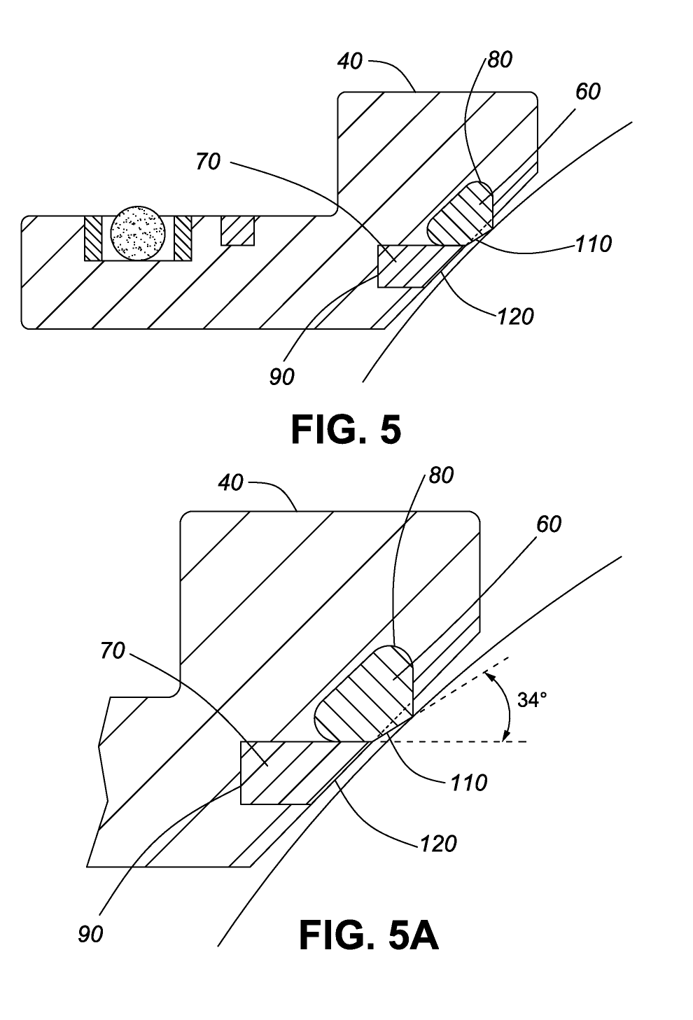

In order to accommodate the seal (60) and insert (70), the contact surface (50) defines annular openings (80, 90); (as seen in cross-section in FIGS. 4 and 5), which act as housing for each of the elastomeric seal (60) and resin insert (70). The seal (60) and opening (80) are immediately adjacent the resin insert (70) and opening (90). Depending on the application, it may also be desirable to have a seat with a single annular opening for the delta ring seal.

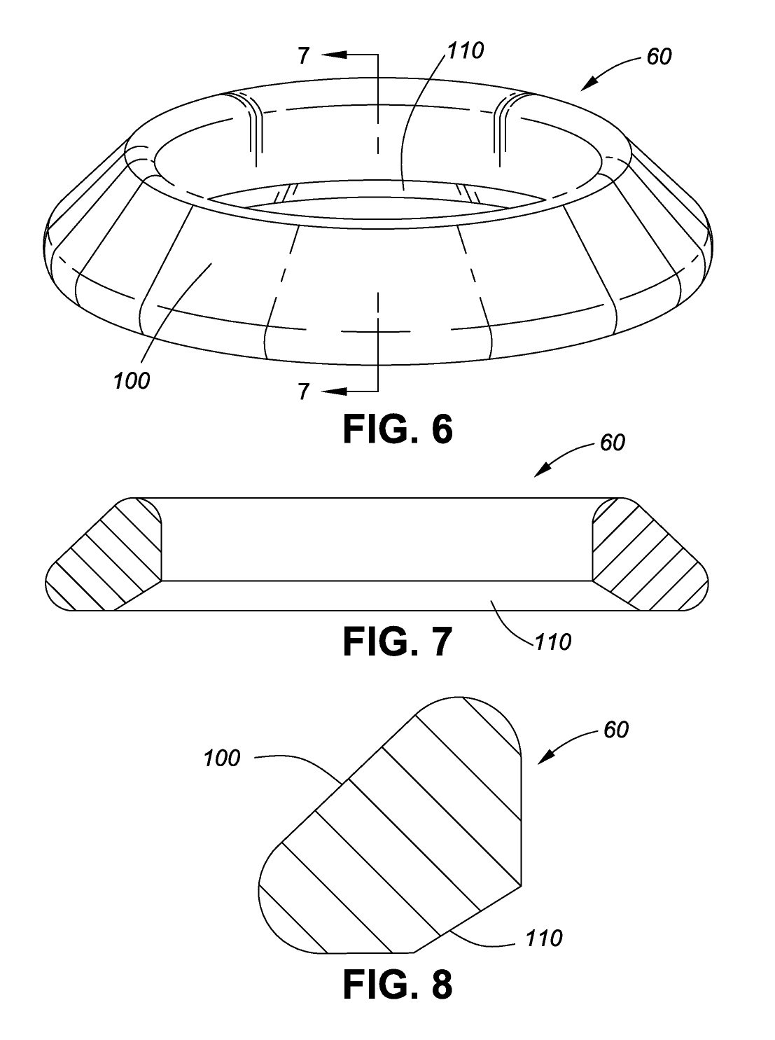

FIG. 6 shows an elastomeric delta ring seal according to the present invention. The seal (60) is substantially triangular (as in delta from the Greek alphabet) with a truncated apex when viewed in cross-section (see FIGS. 5 and 8). A perspective view of a section of the seal (as shown in FIG. 7), substantially has the form of a truncated pyramid. Importantly, the seal (60) is truncated obliquely so that the apex surface (110) is not parallel to the base (100) (see FIG. 8).

As seen in FIG. 5 with reference to FIGS. 7 and 8, the delta ring seal has an apex (110), which points radially inward, and approaches, the ball valve; and a seal base (100). The seal base (100) is wider than the apex (110), and the apex protrudes beyond the opening toward the valve. The seal apex (110) is truncated obliquely (i.e. not parallel to the seal base (100)) to provide the apex with a substantially flat surface while the seal still extends beyond the opening and toward the valve. In such an arrangement, the surfaces of the resin insert and the seal apex (120 and 110) that are orientated radially toward the ball valve are at an angle of less than 180 degrees relative to one another. While a range of different arrangements are possible, Applicant's experiments have shown optimal seal performance and prevention of seal extrusion when the seal (60) is truncated obliquely such that the angle between the seal apex (110) and the resin insert (70) is 34 degrees (see FIG. 5A).

Unexpectedly, the angled delta ring seal arrangement described herein exhibits even better seal performance, including leakage prevention, as compared to prior art arrangements wherein the seal apex is truncated parallel to the seal base, and the surfaces of the resin insert and seal apex are substantially coplanar (i.e. orientated radially toward the ball valve at an angle of 180 degrees relative to one another).

As a ball valve (20) moves through open and closed positions, fluid pressure against the delta ring seal (60) is higher when the valve (20) is only partially open. This is when seals are more likely to be damaged by extrusion. The shape of the seal (60), with its obliquely truncated apex (110), and relatively wider base (100) prevents rotation and extrusion of the seal (60). The seal (60) is nestled and matingly retained within the opening (80), making seal (60) extrusion nearly impossible.

Optionally, holes/channels (80: FIGS. 2 and 3) are drilled to help dissipate the increases in fluid pressure as the ball valve (20) is rotated between open and closed positions.

When a ball (20) is rotated to a closed position, fluid will first encounter the resin insert (70), which prevents leakage toward the seal (60). The resin insert (70) is better able to withstand debris and other particulate matter that may be present within a fluid. If any fluid leaks past the resin insert (70), the seal (60) will prevent the fluid from leaking by past the ball valve.

The unit pressure between the ball (20) and the elastomeric seal (60) is partially due to elastic deformation of the seal (60) when it is completely compressed in its opening within the seat (40). The pressure of any fluid that leaks into the seal (60) opening (80) compresses the seal (60) within the opening (80) and against the ball (20), thereby preventing fluid from leaking any farther into the ball valve (20). The behaviour of the elastomeric seal (60) is similar to that of a liquid in that, when subjected to a certain pressure on a certain zone (contact with the process fluid), it exerts the same pressure on the walls that are wetted by itself.

In addition, the seal (60) insert is self-energized. As the fluid pressure increases, the pressure due to contact between the seal (60) and the ball (20) rises too, exceeding in certain zones the differential pressure of the process fluid and thus creating the seal.

The optional resin insert may be composed of Nylon™, Teflon™, Devlon™, Peek™, and other resin materials known in the art.

1. A delta ring seal for use in a seat for a ball valve, the seat having an annular opening for receiving and holding, said delta ring seal comprising:
an apex pointed radially inward toward the valve; and
a base orientated radially away from the valve, wherein said base is apposite an annular resin insert having a surface disposed toward the ball valve,
wherein said base is wider than said apex, and
wherein said apex is truncated obliquely to define a substantially flat apical surface extending beyond an opening toward the ball valve and terminating at the resin insert.

2. The seal in claim 1, wherein said apex has an apical surface, an angle between said apical surface and the resin insert being 34 degrees.

3. The seal in claim 1, being comprised of elastomeric material.
